(19) United States
(12) Patent Application Publication
(10) Pub. No.: US 2007/0275262 A1
(43) Pub. Date: Nov. 29, 2007

(54) Reducing formation of tin whiskers on a tin plating layer

(76) Inventors: Dechao Lin, Plano, TX (US); Radovan Kovacevic, Plano, TX (US); Donald C. Price, Dallas, TX (US)

Correspondence Address: BAKER BOTTS LLP, 2001 ROSS AVENUE, 6TH FLOOR, DALLAS, TX, 75201-2980, US

(21) Appl. No.: 11/439,019

(22) Filed: May 23, 2006

(51) Int. Cl. B32B 15/01

(52) U.S. Cl. 428/646

(57) ABSTRACT

A plated substrate comprises a plating layer disposed outwardly from a substrate. The substrate comprises a substrate material, where the substrate material comprises a metal. The plating layer comprises a plating material and blocking particles. The plating material comprises grains, and the blocking particles are disposed within interstices between the grains. The blocking particles are scattered substantially uniformly throughout at least a portion of the plating layer, and contribute to formation of boundaries.

### TECHNICAL FIELD

This invention relates generally to the field of metal plating and more specifically to reducing formation of tin whiskers on a tin plating layer.

### BACKGROUND

Plating a substrate involves applying a plating material, such as tin, to the substrate. Over time, however, certain types of plating material may develop protrusions, or “whiskers”. Whiskers may pose reliability concerns for equipment manufacturers and users. As an example, whiskers may cause electrical shorting between adjacent conductors. As another example, whiskers that break free from the plating material may cause mechanical problems.

Some known techniques for reducing whisker formation involve adding material, such as lead, silver, bismuth, or copper, to the plating material. Additives such as lead exhibit effectiveness in reducing whisker formation. Lead, however, has been deemed undesirable for the environment. Other known techniques for reducing whisker formation involve depositing a nickel underlayer prior to depositing the plating material. The underlayer, however, has limited effectiveness over time. It is generally desirable to effectively reduce formation of whiskers on plating materials, while limiting environmental harm.

### SUMMARY OF THE DISCLOSURE

In accordance with the present invention, disadvantages and problems associated with previous techniques for reducing tin whisker formation may be reduced or eliminated.

According to one embodiment of the present invention, plated substrate comprises a plating layer disposed outwardly from a substrate. The substrate comprises a substrate material, where the substrate material comprises a metal. The plating layer comprises a plating material and blocking particles. The plating material comprises grains, and the blocking particles are disposed within interstices between the grains. The blocking particles are scattered substantially uniformly throughout at least a portion of the plating layer, and contribute to formation of boundaries.

According to one embodiment of the present invention, forming a plated substrate includes placing a substrate and a plating material at least partially in a plating solution. The substrate comprises a substrate material and operates as a cathode. The plating material comprises grains and blocking particles, and operates as an anode. The grains and the blocking particles are codeposited outwardly from the substrate to form a plating layer. The blocking particles are disposed within interstices between the grains. The blocking particles are scattered substantially uniformly throughout at least a portion of the plating layer, and contribute to formation of boundaries.

Certain embodiments of the invention may provide one or more technical advantages. A technical advantage of one embodiment may be that blocking particles may form boundaries that at least partially relieve stresses that contribute to the growth of intermetallic compounds formed from the substrate material and the plating material. Relieving these stresses may inhibit or even prevent the formation of whiskers.

Another technical advantage of one embodiment may be that the boundaries formed by the blocking particles may at least partially relieve stresses associated with movement of the plating material towards whisker seeds. Relieving these stresses may inhibit or even prevent the formation of whiskers.

Another technical advantage of one embodiment may be that the formation of whiskers may be inhibited or even prevented without increasing the thickness of the plating layer. Another technical advantage of one embodiment may be that the formation of whiskers may be inhibited or even prevented without the addition of lead.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 is a diagram illustrating one embodiment of a plated substrate with a plating layer that may have little or no whisker formation;

FIG. 2 is a diagram illustrating stresses that may contribute to the formation of a whisker on a plated substrate;

FIG. 3 is a diagram illustrating one embodiment of a system that may be used to codeposit particles to form the plating layer of the plated substrate of FIG. 1; and

FIG. 4 is a diagram illustrating a blocking particle being codeposited in the system of FIG. 3.

### DETAILED DESCRIPTION OF THE DRAWINGS

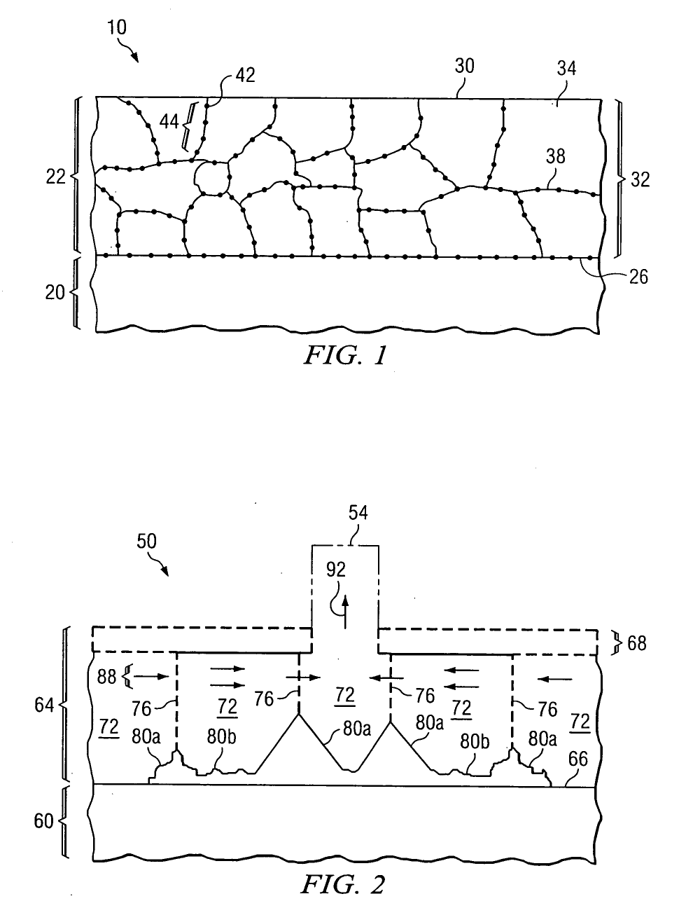

Embodiments of the present invention and its advantages are best understood by referring to FIGS. 1 through 4 of the drawings, like numerals being used for like and corresponding parts of the various drawings.

FIG. 1 is a diagram illustrating one embodiment of a plated substrate 10 with a plating layer 22 that may have little or no whisker formation. Plating layer 22 includes blocking particles 42 that may inhibit or even prevent the formation of whiskers. Blocking particles 42 may form boundaries that at least partially relieve stresses that contribute to the growth of intermetallic compounds formed from the substrate material and the plating material. The boundaries formed by blocking particles 42 may also at least partially relieve stresses associated with movement of the plating material towards a whisker seed. Relieving these stresses may inhibit or even prevent the formation of whiskers. These stresses are described in more detail with reference to FIG. 2.

FIG. 2 is a diagram illustrating stresses that may contribute to the formation of a whisker 54 on a plated substrate 50. The stresses are associated with the growth of intermetallic compounds and movement of plating material.

According to the illustrated example, plated substrate 50 includes a plating layer 64 disposed outwardly from a substrate 60, with an interface 66 disposed between substrate 60 and plating layer 64. Plating layer 64 includes an oxidized layer 68 and grains 72, with interstices 76 disposed between grains 72.

Substrate material of substrate 60 may move into plating material of plating layer 64 to form intermetallic compounds 80 at interface 66. Larger amounts of intermetallic compounds 80a may form proximate to interstices 76, and smaller amounts of intermetallic compounds 80b may form farther away from interstices 76. The increasing volume of compounds 80 yields stresses 84 that operate generally in a direction from substrate 60 towards plating layer 64. The plating material of plated layer 64 may also move in a direction substantially parallel to interface 66 in response to stresses 88. Stresses 84 and 88 may contribute to a stress 90 that may form a whisker 54.

Whisker 54 may generally be electrically conductive and comprise single crystals of the plating material. Whisker 54 may have any suitable size, for example, 1 to 2 millimeters in length and 1 to 3 micrometers in diameter. Whisker 54 may take several days, months, or years to grow.

Referring back to the illustrated embodiment of FIG. 1, plated substrate 10 includes plating layer 22 disposed outwardly from a substrate 20, with an interface 26 disposed between substrate 20 and plating layer 22. Plating layer 22 has an outer surface 30, and includes plating material 32 and blocking particles 42. Plating material 32 comprises grains 34, with interstices 38 disposed between grains 34. Blocking particles 42 are disposed substantially uniformly within plating layer 22 and typically within interstices 38.

Substrate 20 comprises any suitable substrate material, for example, a metal such as copper or brass. Plating layer 22 comprises any suitable plating material 32, for example, a metal such as tin.

A blocking particle 42 may represent a particle disposed within an interstice 38 between grains 34, and a plurality of blocking particles 42 may at least reduce the formation of whiskers 54. A blocking particle 42 may have any suitable shape and size to fit within an interstice 38. A blocking particle 42 may, for example, have a highly polygonized shape. A blocking particle 42 may, for example, have an average diameter in the range of less than 100 nanometers, less than 50 nanometers, less than 40 nanometers, or less than 30 nanometers, such as approximately 20 nanometers. An average diameter may refer to the average of the diameters of a substantially spherical shape. Blocking particles 42 of plating layer 22 may have substantially the same average diameter.

Plating layer 22 may comprise any proportion of blocking particles 42 suitable to at least reduce the formation of whiskers 54. For example, blocking particles 42 may comprise less than 5%, less than 3%, less than 1%, less than 0.5%, such as 0.25% blocking particles. Blocking particles 42 may comprise any suitable material, for example, a metal such as nickel, copper, iron, titanium dioxide, bismuth, other suitable material, or any combination of the preceding. Blocking particles 42 may comprise a material different from the material of grains 34.

Blocking particles 42 may inhibit or even prevent the formation of whiskers 54. According to one embodiment, blocking particles 42 may at least partially relieve one or more stresses 84 and 88 that may contribute to the formation of whiskers 54.

According to the embodiment, blocking particles 42 may form a boundary 44 at interface 26 and interstices 38. Boundary 44 may operate to at least partially relieve stresses that contribute to the formation of whiskers 54. Boundary 44 may or may not be continuous in order to at least partially relieve the stresses. That is, boundary 44 may include breaks between blocking particles 42.

The boundaries may at least partially relieve one or more stresses 84 and 88. For example, the boundaries may at least partially relieve stresses 84, which may reduce or prevent the formation of intermetallic compounds 80, and may at least partially relieve stresses 88, which may reduce or prevent the movement of plating material 32. Relieving these stresses may inhibit or even prevent the formation of whiskers.

Other parameters may be adjusted to reduce the growth of whiskers. As an example, certain materials of substrate 20 may be more prone to whisker formation. Brass, copper, and copper alloys may be more prone to whisker formation. As a second example, a thicker plating layer 22 may be less prone to whisker formation.

Plated substrate 10 may be used in any suitable application. For example, plated substrate 10 may be used in electronic components such as electromagnetic relays, fuses, leads, microcircuits, test points, terminal lugs, wiring boards, capacitors, resistors, or other components.

Modifications, additions, or omissions may be made to plated substrate 10 without departing from the scope of the invention. Plated substrate 10 may include more, fewer, or other layers. For example, another layer may be disposed outwardly from plated substrate 10, or plated substrate 10 may be disposed outwardly from another layer. As used in this document, “each” refers to each member of a set or each member of a subset of a set.

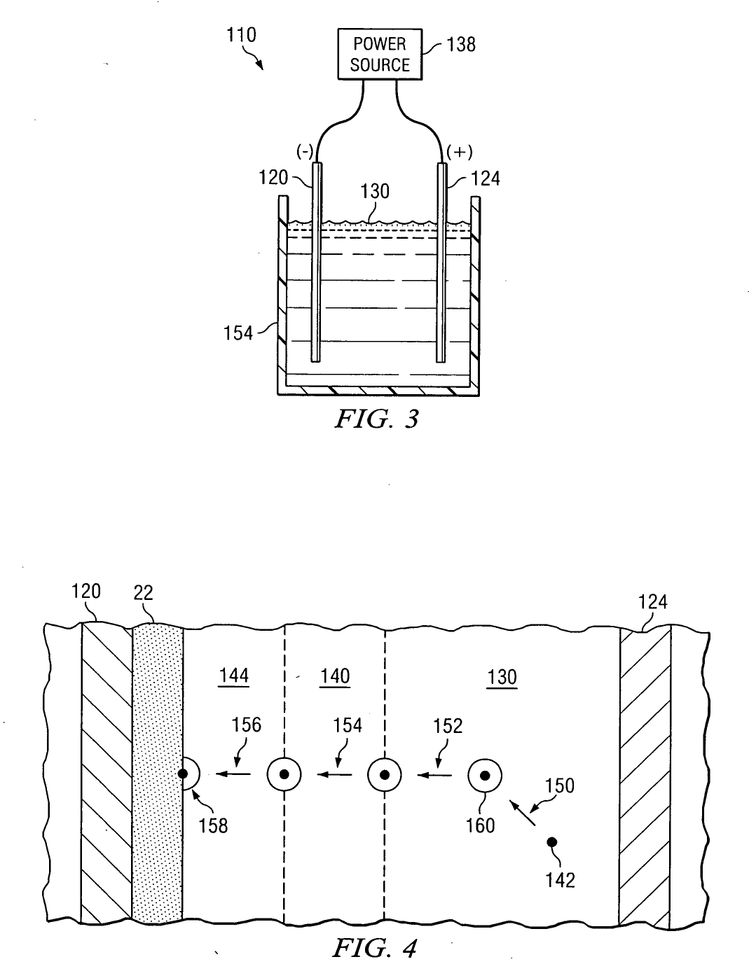

FIG. 3 is a diagram illustrating one embodiment of a system 110 that may be used to codeposit particles to form plating layer 22 of plated substrate 10 of FIG. 1. According to the illustrated embodiment, system 110 includes a cathode 120 and an anode 124 substantially immersed in a plating solution 130 that is housed in a receptacle 154. Cathode 120 and anode 124 are coupled to a power source 138 that supplies power to control the codeposition process.

Cathode 120 may comprise any suitable substrate material, for example, a metal such as copper or brass. Anode 124 may comprise any suitable material that may be used to form plating layer 22 comprising plating material 32 and blocking particles 48. According to one embodiment, anode 124 comprises a composite anode in which blocking particles 48 are substantially uniformly disposed with plating material 32.

Anode 124 may be fabricated in any suitable manner, for example, according to a hot embossing process. Hot embossing involves softening a material by raising the temperature of the material just above the softening transition temperature, but below the melting point. A pattern is stamped into the softened material. The stamping may uniformly distribute blocking particles 48 throughout plating material 32.

Plating solution 130 may comprise any suitable chemical solution that transports grains 34 and blocking particles 48 at substantially the same rate to distribute blocking particles 42 substantially uniformly throughout plating material 32. Plating solution may include, for example, an acid such as sulfuric acid H₂(SO₄), a concentration of plating material such as a tin concentration, a brightener, and/or water, in any suitable proportion. Plating solution 130 may comprise any other suitable solution, for example, an acid fluoride-chloride solution or a pyrophosphate citrate solution.

Modifications, additions, or omissions may be made to system 110 without departing from the scope of the invention. The components of system 110 may be integrated or separated according to particular needs. Moreover, the operations of system 110 may be performed by more, fewer, or other components.

FIG. 4 is a diagram illustrating codeposition of particles to form plating layer 22 using system 110 of FIG. 3. Codeposition may refer to a technique used to deposit a composite layer by embedding particles added to a plating solution into a metal matrix.

According to the illustrated embodiment, a particle 142, such as a blocking particle 42 or grain 34, released from anode 124 travels through plating solution 130 and layers 140 and 144 towards cathode 120 to form plating layer 22. Diffusion layer 144 represents a diffusion double layer, and boundary layer 140 represents a hydrodynamic boundary layer. Particles 142 may be suspended in plating solution 130 during travel using any suitable method, for example, using mechanical or air agitation.

Particle 142 proceeds stages 150 through 158 during the codeposition process. At stage 150, an ionic cloud 160 forms around blocking particle 42 by adsorption of the ionic species upon the particle surface. Clouds 160 may be created by adding particles 142 to plating solution 130 or by pre-treating particles 42 in ionic solutions.

A convection force moves particle 142 towards boundary layer 140 at stage 152. Particle 142 diffuses through diffusion layer 144 at stage 154. Particle 142 is adsorbed at cathode 120 at stage 156. The ionic species of ionic cloud 160 is reduced at stage 158 to incorporate particle 142 into the matrix of plating layer 22.

Blocking particles 42 may be codeposited with grains 34 by any suitable mechanism, for example, electrophoretic movement of positively charged particles 142 towards cathode 120, adsorption of particles 142 at the electrode surface by Van der Waals forces, or mechanical inclusion of particles 142 at layer 22.

Modifications, additions, or omissions may be made to the method without departing from the scope of the invention. The method may include more, fewer, or other steps. Additionally, steps may be performed in any suitable order without departing from the scope of the invention.

Certain embodiments of the invention may provide one or more technical advantages. A technical advantage of one embodiment may be that blocking particles may form boundaries that at least partially relieve stresses that contribute to the growth of intermetallic compounds formed from the substrate material and the plating material. Relieving these stresses may inhibit or even prevent the formation of whiskers.

Another technical advantage of one embodiment may be that the boundaries formed by the blocking particles may at least partially relieve stresses associated with movement of the plating material towards whisker seeds. Relieving these stresses may inhibit or even prevent the formation of whiskers.

Another technical advantage of one embodiment may be that the formation of whiskers may be inhibited or even prevented without increasing the thickness of the plating layer. Another technical advantage of one embodiment may be that the formation of whiskers may be inhibited or even prevented without the addition of lead.

While this disclosure has been described in terms of certain embodiments and generally associated methods, alterations and permutations of the embodiments and methods will be apparent to those skilled in the art. Accordingly, the above description of example embodiments does not constrain this disclosure. Other changes, substitutions, and alterations are also possible without departing from the spirit and scope of this disclosure, as defined by the following claims.

What is claimed is:

1. A plated substrate, comprising:
a substrate comprising a substrate material, the substrate material comprising a metal; and
a plating layer disposed outwardly from the substrate, the plating layer comprising:
a plating material comprising a plurality of grains; and
a plurality of blocking particles, a blocking particle of the plurality of blocking particles disposed within an interstice between at least two grains of the plurality of grains, the plurality of blocking particles scattered substantially uniformly throughout at least a portion of the plating layer, the plurality of blocking particles operable to contribute to formation of one or more boundaries.

2. The plated substrate of claim 1, the one or more boundaries operable to:
at least partially relieve a stress operating substantially in a direction from the substrate towards the plating layer.

3. The plated substrate of claim 1, the one or more boundaries operable to:
at least inhibit growth of an intermetallic compound formed from the substrate material and the plating material.

4. The plated substrate of claim 1, the one or more boundaries operable to:
at least partially relieve a stress operating in a direction substantially parallel to an interface between the substrate and the plating layer.

5. The plated substrate of claim 1, the one or more boundaries operable to:
at least inhibit movement of the plating material.

6. The plated substrate of claim 1, a blocking particle having an average diameter of less than 50 nanometers.

7. The plated substrate of claim 1, the plurality of blocking particles comprising nickel.

8. The plated substrate of claim 1, the plating material comprising tin.

9. The plated substrate of claim 1:
the one or more boundaries operable to:
at least partially relieve a stress operating substantially in a direction from the substrate towards the plating layer;
at least inhibit growth of an intermetallic compound formed from the substrate material and the plating material;
at least partially relieve a stress operating in a direction substantially parallel to an interface between the substrate and the plating layer; and
at least inhibit movement of the plating material;
a blocking particle having an average diameter of less than 50 nanometers;
the plurality of blocking particles comprising nickel; and
the plating material comprising tin.

10. A method for forming a plated substrate, comprising:
placing a substrate and a plating material at least partially in a plating solution, the substrate comprising a substrate material and operating as a cathode, the plating material operating as an anode, the plating material comprising a plurality of grains and a plurality of blocking particles; and
codepositing the plurality of grains and the plurality of blocking particles outwardly from the substrate to form a plating layer, a blocking particle of the plurality of blocking particles disposed within an interstice between at least two grains of the plurality of grains, the plurality of blocking particles scattered substantially uniformly throughout at least a portion of the plating layer, the plurality of blocking particles operable to contribute to formation of one or more boundaries.

11. The method of claim 10, the plating solution operable to:
transport the plurality of grains and the plurality of blocking particles at substantially the same rate.

12. The method of claim 10, a blocking particle having an average diameter of less than 50 nanometers.

13. The method of claim 10, a blocking particle comprising nickel.

14. The method of claim 10, the one or more boundaries operable to:
at least inhibit movement of the plating material.

15. A system for forming a plated substrate, comprising:
a substrate at least partially placed in a plating solution, the substrate comprising a substrate material and operating as a cathode; and
a plating material at least partially placed in the plating solution, the plating material operating as an anode, the plating material comprising a plurality of grains and a plurality of blocking particles;
the substrate and the plating material operable to receive an electrical current to codeposit the plurality of grains and the plurality of blocking particles outwardly from the substrate to form a plating layer, a blocking particle of the plurality of blocking particles disposed within an interstice between at least two grains of the plurality of grains, the plurality of blocking particles scattered substantially uniformly throughout at least a portion of the plating layer, the plurality of blocking particles operable to contribute to formation of one or more boundaries.

16. The system of claim 15, the plating solution operable to:
transport the plurality of grains and the plurality of blocking particles at substantially the same rate.

17. The system of claim 15, a blocking particle having an average diameter of less than 50 nanometers.

18. The system of claim 15, a blocking particle comprising nickel.

19. The system of claim 15, the one or more boundaries operable to:
at least inhibit movement of the plating material.

20. The system of claim 15, the plating solution operable to:
transport the plurality of grains and the plurality of blocking particles at substantially the same rate.

21. A system for forming a plated substrate, comprising:
means for placing a substrate and a plating material at least partially in a plating solution, the substrate comprising a substrate material and operating as a cathode, the plating material operating as an anode, the plating material comprising a plurality of grains and a plurality of blocking particles; and
means for codepositing the plurality of grains and the plurality of blocking particles outwardly from the substrate to form a plating layer, a blocking particle of the plurality of blocking particles disposed within an interstice between at least two grains of the plurality of grains, the plurality of blocking particles scattered substantially uniformly throughout at least a portion of the plating layer, the plurality of blocking particles operable to contribute to formation of one or more boundaries.
